(19) United States
(12) Patent Application Publication
(10) Pub. No.: US 2017/0372288 A1
(43) Pub. Date: Dec. 28, 2017

(54) APPARATUS AND METHOD FOR CONTROLLING A SWITCH

(71) Applicant: MasterCard Asia/Pacific Pte. Ltd., Singapore (SG)

(72) Inventors: Jiaming Li, Singapore (SG); Jie Zhang, Singapore (SG)

(21) Appl. No.: 15/626,460

(22) Filed: Jun. 19, 2017

(30) Foreign Application Priority Data
Jun. 22, 2016 (SG) 10201605157R

(51) Int. Cl. G06Q 20/20; G06Q 20/40; H01R 13/70; H01R 24/28; H01R 24/20; H01H 47/00

(52) U.S. Cl. CPC G06Q 20/204; H01R 24/28; H01R 24/20; G06Q 20/40; H01R 13/70; H01H 47/00

(57) ABSTRACT

A method of controlling a switch to selectively provide electrical power to an appliance, the method including, in one or more electronic processing devices: (a) providing a service token to a user device, the service token being indicative of one or more pre-selected payment options associated with providing power to the appliance, the user device being responsive to the service token to: (i) provide the service token to a payment system via a communications network; (ii) receive from the payment system an indication of the payment options associated with the service token; (iii) provide payment information to the payment system in accordance with a payment option selected by the user; and (iv) receive a payment token from the payment system in response to successful payment using the provided payment information; (b) receiving the payment token from the user device; and, (c) using the payment token to control the switch.

### BACKGROUND OF THE INVENTION

The present invention relates to an apparatus and method for controlling a switch to thereby selectively provide electrical power to an appliance.

### DESCRIPTION OF THE PRIOR ART

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

Electricity is consumed by all manner of electrical devices including for example heaters, lights, fridges, washing machines, fans, televisions etc. Typically, usage is recorded by an electricity company and an account owner is billed on a periodical basis. Due to the way in which electricity is consumed, consumers typically do not appreciate just how much electricity they may be using on a daily basis. Accordingly, usage and accounts tend to fluctuate, often leading to unexpected amounts payable each payment cycle. It would be desirable therefore to introduce a method of providing electricity to power appliances that was able to make consumers more aware of the cost of the electricity consumed and conscious of their energy usage.

Hotel owners and accommodation providers, including Airbnb™ typically charge customers for rooms on a per night basis. The room rate typically remains constant regardless of the amount of electricity consumed by the customer during their stay. In order to increase revenue and encourage more efficient use of electricity in their premises, it would also be desirable to be able to introduce some control of the usage of electrical appliances provided in the room for the guest by charging guests for their usage of those appliances.

Self-service machine manufacturers such as manufacturers of commercial washing machines and dryers, event or gymnasium lockers, or parking ticket machines typically provide for payment by coin or credit card. If you do not have the correct denomination of coins, sufficient money or a credit card then payment and use of the self-service machine may not be possible. This leads to inconvenience for the consumer and loss of business for the machine operator/owner. It would be desirable to allow a consumer to use a self-service machine without requiring coins or a physical credit card to be presented to the machine.

It is also generally desirable to improve consumer experiences with making payments for goods and services and to improve merchant experiences with making payments.

It is against this background, and the problems and difficulties associated therewith, that the present invention has been developed.

### SUMMARY OF THE PRESENT INVENTION

There is provided a method of controlling a switch to thereby selectively provide electrical power to an appliance, the method including, in one or more electronic processing devices: (a) providing a service token to a user device, the service token being indicative of one or more pre-selected payment options associated with providing power to the appliance, the user device being responsive to the service token to: (i) provide the service token to a payment system via a communications network; (ii) receive from the payment system an indication of the payment options associated with the service token; (iii) provide payment information to the payment system in accordance with a payment option selected by the user; and; (iv) receive a payment token from the payment system in response to successful payment using the provided payment information; (b) receiving the payment token from the user device; and, (c) using the payment token to control the switch to thereby provide electrical power to the appliance at least partially in accordance with the payment option selected by the user.

Preferably, the one or more pre-selected payment options are associated with at least one of: (a) providing power to the appliance for a pre-determined amount of time; (b) providing a pre-determined amount of electrical power to the appliance; and, (c) providing an amount of power to the appliance in accordance with an electrical parameter of the appliance.

It is preferable that the one or more electronic processing devices communicate with the user device via a wireless communications protocol, the wireless communications protocol includes Bluetooth™ Low Energy (BLE) protocol.

The method can further include, in the one or more electronic processing devices, validating the payment token using a device identifier associated with the switch.

It is preferable that the step of validating the payment token using the device identifier includes at least one of: (a) decrypting the payment token using a key of the device identifier; (b) using the device identifier to determine that the payment token has been received by an intended switching device; and, (c) determining that the payment option selected by the user is valid for the switching device.

The method can further include, in the one or more electronic processing devices: (a) controlling the switch to provide electrical power to the appliance; (b) starting a timer; (c) using the timer to determine an elapsed time since control of the switch was initiated; (d) determining whether the elapsed time exceeds a pre-determined amount of time indicative of a purchased duration of electrical power supply to the appliance and, (e) in response to determining that the pre-determined amount of time has been exceeded, controlling the switch to cut-off electrical power supply to the appliance.

The method can further include, in the one or more electronic processing devices: (a) monitoring an electrical current drawn by the appliance; and, (b) controlling the switch at least partially in accordance with the current drawn.

The method can also further include, in the one or more electronic processing devices: (a) controlling the switch to provide electrical power to the appliance; (b) monitoring an electrical current drawn by the appliance; (c) determining if the electrical current exceeds a threshold; (d) in response to determining that the threshold has been exceeded, starting a timer; (e) using the timer to determine an elapsed time since the threshold was exceeded; (f) determining whether the elapsed time exceeds a pre-determined amount of time indicative of a purchased duration of electrical power supply to the appliance; and, (g) in response to determining that the pre-determined amount of time has been exceeded, controlling the switch to cut-off electrical power supply to the appliance.

It is preferable that the threshold is based on a working current of the appliance.

The method can further include, in the one or more electronic processing devices, communicating with a merchant device via a wireless communications protocol in order to pre-configure the switch device prior to use by the user.

The method can also further include, in the one or more electronic processing devices: (a) generating an initialization token; (b) providing the initialization token to the merchant device, the merchant device being responsive to the initialization token to: (i) register the initialization token with the one or more payment options associated with providing electrical power to the appliance; (ii) provide the registered initialization token to a payment system, the payment system responsive to generate provisioning data for use in controlling the switch; (iii) receive the provisioning data from the payment system; (c) receive the provisioning data from the merchant device; and, (d) store the provisioning data in a data store, the provisioning data being used to at least partially control the switch in accordance with the payment option selected by the user.

It is preferable that the initialization token is generated using a device identifier associated with the switch, the device identifier being stored in at least one of: (a) a local data store, the local data store forming part of a switching device including the switch and the one or more electronic processing devices; and, (b) a remote data store, the remote data store being remote to the switching device and in communication with the one or more electronic processing devices via a communications network.

It is also preferable that the provisioning data for use in controlling the switch includes at least one of: (a) a merchant identifier associated with the merchant; (b) a device identifier associated with the switch; (c) an indication of the payment options provided by the merchant associated with providing electrical power to the appliance; and, (d) instructions for use in controlling the switch in accordance with the payment options. Preferably, a device identifier associated with the switch is a unique key.

The method can also further include, in the one or more electronic processing devices, validating the provisioning data prior to storage in the data store.

There is also provided an apparatus for controlling a switch to thereby selectively provide electrical power to an appliance, the apparatus including one or more electronic processing devices that: (a) provide a service token to a user device, the service token being indicative of one or more pre-selected payment options associated with providing power to the appliance, the user device being responsive to the service token to: (i) provide the service token to a payment system via a communications network; (ii) receive from the payment system an indication of the payment options associated with the service token; (iii) provide payment information to the payment system in accordance with a payment option selected by the user; and, (iv) receive a payment token from the payment system in response to successful payment using the provided payment information; (b) receive the payment token from the user device; and, (c) use the payment token to control the switch to thereby provide electrical power to the appliance at least partially in accordance with the payment option selected by the user.

It is preferable that the apparatus includes a switch for electrically connecting the appliance to an electrical supply.

The apparatus can include a wireless transceiver module and wherein the one or more electronic processing devices communicate with the user device via the wireless transceiver module. The wireless transceiver module can be a Bluetooth™ transceiver module.

The apparatus can further include a switch housing including: (a) a plug for releasable engagement to a wall mounted electrical power outlet; and, (b) a socket for receiving an electrical plug associated with the appliance.

Preferably, the apparatus can further include a switch housing adapted for securement to a wall mounted electrical power outlet and/or a current sensor for monitoring a level of current through the switch.

The apparatus can also include a timer used by the one or more electronic processing devices to determine an elapsed time indicative of at least one of: (a) a time period since control of the switch was initiated; and, (b) a time period since a level of current through the switch exceeded a threshold that is based on a working current of the appliance.

There is also provided a method for use in controlling a switch to thereby selectively provide electrical power to an appliance, the method including, in the one or more electronic processing devices: (a) generating an initialization token; (b) providing the initialization token to the merchant device, the merchant device being responsive to the initialization token to: (i) register the initialization token with one or more payment options associated with providing electrical power to the appliance; (ii) provide the registered initialization token to a payment system, the payment system responsive to generate provisioning data for use in controlling the switch; (iii) receive the provisioning data from the payment system; (c) receiving the provisioning data from the merchant device; and, (d) storing the provisioning data in a data store, the provisioning data being used to at least partially control the switch in accordance with the payment option selected by the user.

There is also provided a power outlet for providing electrical power, the power outlet including: (a) a switch housing embedded into the outlet, the switch housing containing a switch controllable to selectively provide electrical power to an appliance connected to the outlet; and, (b) one or more electronic processing devices that: (i) provide a service token to a user device, the service token being indicative of one or more pre-selected payment options associated with providing power to the appliance, the user device being responsive to the service token to: (1) provide the service token to a payment system via a communications network; (2) receive from the payment system an indication of the payment options associated with the service token; (3) provide payment information to the payment system in accordance with a payment option selected by the user; and, (4) receive a payment token from the payment system in response to successful payment using the provided payment information; (ii) receive the payment token from the user device; and, (iii) use the payment token to control the switch to thereby provide electrical power to the appliance at least partially in accordance with the payment option selected by the user.

There is also provided an adaptor releasably engageable to a power outlet, the adaptor including: (a) a housing containing: (i) a switch that is controllable to selectively provide electrical power to an appliance connected to the power outlet via the adaptor; and, (ii) one or more electronic processing devices that: (1) provide a service token to a user device, the service token being indicative of one or more pre-selected payment options associated with providing power to the appliance, the user device being responsive to the service token to: (a) provide the service token to a payment system via a communications network; (b) receive from the payment system an indication of the payment options associated with the service token; (c) provide payment information to the payment system in accordance with a payment option selected by the user; and, (d) receive a payment token from the payment system in response to successful payment using the provided payment information; (2) receive the payment token from the user device; and, (3) use the payment token to control the switch to thereby provide electrical power to the appliance at least partially in accordance with the payment option selected by the user; and, (b) a plug for releasable engagement into a socket of the power outlet; and, (c) a socket for receiving a plug associated with the appliance.

Finally, there is also provided a method of controlling a switch to thereby selectively provide electrical power to an appliance, the method including, in one or more electronic processing devices: (a) receiving a service token from a switch controller, the service token being indicative of one or more pre-selected payment options associated with providing power to the appliance; (b) providing the service token to a payment system via a communications network; (c) receiving from the payment system an indication of the payment options associated with the service token; (d) receiving an indication of a payment option selected by the user; (e) providing payment information to the payment system in accordance with the payment option selected by the user; (f) receiving a payment token from the payment system in response to successful payment using the provided payment information; (g) providing the payment token to the switch controller, the switch controller responsive to the payment token to control the switch to thereby provide electrical power to the appliance at least partially in accordance with the payment option selected by the user.

It will be appreciated that the broad forms of the invention and their respective features can be used in conjunction, interchangeably and/or independently, and reference to separate broad forms in not intended to be limiting.

### BRIEF DESCRIPTION OF THE DRAWINGS

A non-limiting example of the present invention will now be described with reference to the accompanying drawings, in which:

FIG. 1 is a flow chart of an example of a method of controlling a switch to thereby selectively provide electrical power to an appliance;

FIG. 2 is a schematic diagram of an example of a system for controlling a switch to thereby selectively provide electrical power to an appliance;

FIG. 3 is a schematic diagram showing components of an example user device of the system shown in FIG. 2;

FIG. 4 is a schematic diagram showing components of an example payment processing device of the system shown in FIG. 2;

FIGS. 5A to 5C is a flowchart of a specific example of a method of controlling a switch to thereby selectively provide electrical power to an appliance;

FIGS. 6A to 6B is a flowchart of an example of a method of controlling a switch to provide power to an appliance using a timer and monitoring a current drawn by the appliance;

FIG. 7 is a flowchart of an example of a method of controlling a switch to provide power to an appliance using a timer only;

FIG. 8 is a flowchart of an example of a method of controlling a switch to provide power to an appliance based on monitoring a current drawn by the appliance only;

FIG. 9 is a flowchart of an example of a method of configuring a switching device that is controllable to thereby selectively provide electrical power to an appliance;

FIG. 10 is an example of a merchant setup of a switching device that is controllable to thereby selectively provide electrical power to an appliance;

FIG. 11 is an example of a user payment process used in controlling a switch to thereby selectively provide electrical power to an appliance;

FIG. 12 shows an example of a paid duration of use of a appliance based on current drawn by the appliance; and,

FIG. 13 provides an example of hardware associated with the system of controlling a switch to selectively provide electrical power to an appliance.

### DETAILED DESCRIPTION OF THE PREFERRED EMBODIMENTS

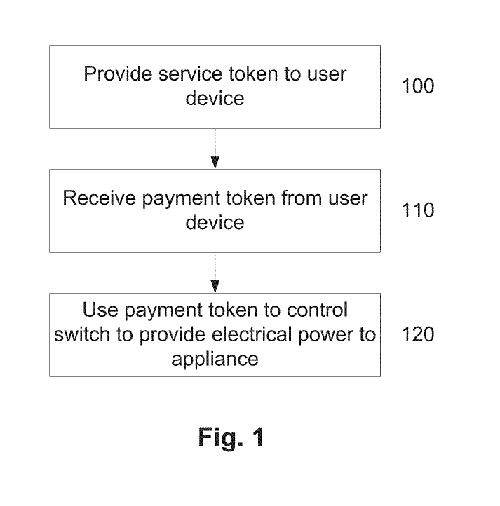

An example of a method of controlling a switch to thereby selectively provide electrical power to an appliance will now be described with reference to FIG. 1.

For the purpose of illustration, it is assumed that the method is performed at least in part using one or more electronic processing devices such as a suitably programmed microcontroller forming part of a switching device capable of controlling the switch and in communication with one or more user and merchant devices, such as mobile phones, portable computers, tablet computers, or the like. The user and merchant devices are also typically in communication with a payment system which may comprise any suitable computer system such as a server that is capable of processing payments made by the user and which may include a number of processing devices associated with each of an issuer, acquirer, card network and payment gateway, or alternatively, the payment processing system may include any one or more of these entities and this will be discussed further below.

The term appliance is intended to cover any electrical device that consumes power and will typically refer to consumer appliances such as washing machines, dryers, phone or battery chargers, televisions, lamps, fridges, dishwashers, heaters and the like, although industrial machines and devices may also be included.

In this example, at step 100 the one or more electronic processing devices provide a service token to a user device, the service token being indicative of one or more pre-selected payment options associated with providing power to the appliance. The payment options associated with a particular appliance will typically have been pre-selected by a merchant who may the manufacturer or operator/owner of the appliance. The payment options will typically be specific for the appliance and the functionality that it provides. For example, a washing machine or dishwasher may provide multiple payment options for particular wash cycles or durations whilst a phone charger may simply provide a single payment option to fully charge a mobile phone. As will be described further below, whilst typically a user will pay to power an appliance for a given period of time, in alternative examples, the user may pay for a pre-determined amount of power or pay for the use of the appliance for a specific purpose such as charging a phone (which would not necessarily be based on time). In further alternative examples, the user may pay for unrestricted access to power over a given period of time, such as, for example, weekly, monthly, quarterly, half-yearly, annually, and so forth.

Typically, the one or more electronic processing devices user communicate with the user device to provide the service token via a wireless communications protocol such as Bluetooth, Zigbee, Wi-fi and the like. In one example, the switching device includes a wireless transceiver such as a Bluetooth™ Low Energy (BLE) module. In one example, the electronic processing device is configured to provide a wireless hotspot to which the user device may be connected or paired. When the user comes within a certain vicinity of the switching device they will be able to connect or pair with the switching device in order to establish communication therewith.

Having received the service token, the user device is typically responsive to provide the service token to a payment system via a communications network. The payment system is able to interpret the service token to determine the payment options that are associated with the service token for the specific appliance. This information will have previously been provided to the payment system from the merchant when configuring the switching device before use, as will be described in more detail below.

The user device then receives from the payment system an indication of the payment options associated with the service token. For example, the payment system may cause a user interface such as payment webpage to be displayed on the user device which provides a representation of the payment options (such as $1.00 for 3 minutes, $2.00 for 6 minutes, $30.00 for unrestricted use over a week, etc.). The user then selects a desired payment option for example by clicking on a button indicative of the payment option and proceeds to checkout to pay for the use of the appliance. In this way, the user provides payment information to the payment system in accordance with the payment option selected by the user. The transaction may then be processed in a similar way to which a standard ecommerce transaction is performed with a merchant. In response to successful payment using the provided payment information, the user device then receives a payment token from the payment system.

At step 110, the one or more electronic processing devices then receive the payment token from the user device. In this regard, the same wireless communication protocol previously described is used by the user device to send the payment token to the switching device. In this regard, after receiving the payment token from the payment system, the user may be prompted through a user interface or via a message to send the payment token to the switching device.

At step 120, the one or more electronic processing devices then use the payment token to control the switch to thereby provide electrical power to the appliance at least partially in accordance with the payment option selected by the user. In this regard, the payment token will be indicative of the payment option selected by the user and the switching device will be able to interpret the payment token to control the switch in accordance with the selected payment option as will be described in further detail below.

Thus, once the payment token has been received, the processing device can cause the switch to open or close in order to provide and cut-off power to the appliance respectively. In this regard, it will be appreciated that the switching device including the switch can be located between a power supply and the appliance such that the switch is operable to selectively interconnect the appliance to the power supply. As will be described in more detail later, in one example the switching device forms parts of or comprises an adaptor which may be located between a power outlet and the appliance. Alternatively, the switching device may be embedded into the power outlet such than an appliance can be plugged directly into a wall outlet for example, or could be incorporated into the appliance.

The above described method and apparatus provides a number of advantages.

Firstly, the method enables an appliance to be used on a ‘pay per use’ basis without requiring any physical coins, bank notes banks cards to be presented for payment. This overcomes many of the drawbacks of using commercial self-service machines such as washing machines and dryers which typically require specific denominations of coins for use that a user might not always have. This simplicity of payment may therefore lead to increased uptake and use of such machines leading to increased sales and profitability for machine owners.

Enabling appliances to be operated on a ‘pay per use’ basis also provides accommodation suppliers such as hotels and Airbnb™ room owners the opportunity to create an additional revenue stream from use of appliances provided in their rooms for the use of guests.

Furthermore, ‘pay per use’ appliances may assist in reducing energy usage by encouraging users to become more conscious of the amount of electricity that they use, particularly when they learn to correlate use of an appliance with a specific cost. This may be more readily achieved by paying each time an appliance is used rather than paying an overall energy bill for a property on a periodic basis such as quarterly as is typically the case at present.

In addition, the method also enables an appliance to be used on a subscription basis without requiring any physical coins, bank notes banks cards to be presented for payment. This provides convenience of using commercial self-service machines over an extended duration of time in a “use-on-demand” manner. This simplicity of payment may therefore lead to increased uptake and use of such machines leading to increased sales and profitability for machine owners.

A number of further features will now be described.

As previously mentioned the one or more payment options may be associated with various parameters. In one example, the payment options are associated with providing power to the appliance for a pre-determined amount of time. In this example the user pays for use of the appliance for a certain duration of time, typically defined in minutes or hours of usage (e.g. $1.00 to use a fan for 5 minutes, $2.00 to use the fan for 10 minutes). In another example, the user pays for unrestricted use of the appliance over a pre-determined duration of time, typically defined in weeks or months of usage (e.g. $30.00 to use a fan “on-demand” over a course of a month). In another example, the payment options are associated with providing a pre-determined amount of electrical power to the appliance (for example measured in kW or kWh). The payment options could further be based on the current price of the power so that it is purchased for example when prices are lower in off-peak. In yet a further example, the payment options are associated with providing an amount of power to the appliance in accordance with an electrical parameter of the appliance. For example, an electrical parameter could be the state of charge of a battery and the user pays to fully charge the battery which may be associated with a mobile phone or computer for example. The state of charge may be monitored directly or inferred based on a different parameter such as the current drawn by the appliance for example.

In one example, the one or more electronic processing devices communicate with the user device via a wireless communication protocol as previously mentioned. In one example, the wireless communications protocol includes Bluetooth™ Low Energy (BLE) protocol however any other suitable protocol or form of wireless communication may be used including Wi-Fi, Zigbee or Near Field Communication (NFC).

Typically, the one or more electronic processing devices validate the payment token using a device identifier associated with the switch, such as a unique device key assigned to the switch during the manufacturing process. The validation step typically occurs after the switching device has received the payment token from the user device and prior to initiating control of the switch to selectively provide power to the appliance.

The step of validating the payment token using the device identifier may include a number of aspects. For instance, the payment token generated by the payment system may be encrypted using a key derived from the device identifier. In this case, part of the validation step would include decrypting the payment token using the key derived from the device identifier. In this way, the device identifier may be used to determine that the payment token has been received by the intended switching device, as well as to ensure the payment token is a legitimate payment token generated by the payment system. A further validation step may include determining that the payment option selected by the user (and associated with the payment token) is valid for the particular switching device. The step of validating the payment token may therefore ensure that the payment token has not been inadvertently sent or received by an incorrect switch, and that a payment option that is actually provided by the particular switching device has been selected.

A number of ways of controlling the switch to provide electrical power to an appliance are contemplated. In one example, after receiving and optionally validating the payment token, the switching device controls the switch to provide electrical power to the appliance and starts a timer. The timer is used to determine an elapsed time since control of the switch was initiated. The switching device then determines whether the elapsed time exceeds a pre-determined amount of time indicative of a purchased duration of electrical power supply to the appliance. In response to determining that the pre-determined amount of time has been exceeded, the switching device controls the switch to cut-off electrical power supply to the appliance. In this way, a user pays to use the appliance for a pre-determined amount of time and control of the switch is simply based on a timer. For example, in the case of operating a fan for 3 minutes, the switch would be controlled to turn the fan on, a timer is started and after 3 minutes, the switch is controlled to turn the fan off again.

In a further example, the one or more electronic processing devices monitor an electrical current drawn by the appliance and control the switch at least partially in accordance with the current drawn. For example, after receiving and optionally validating the payment token, the switching device controls the switch to provide electrical power to the appliance and monitors an electrical current drawn by the appliance (using a suitable current sensor). The switching device then determines if the electrical current exceeds a threshold and in response to determining that the threshold has been exceeded, starts a timer that is used to determine an elapsed time since the threshold was exceeded. The switching device then determines whether the elapsed time exceeds a pre-determined amount of time indicative of a purchased duration of electrical power supply to the appliance and in response to determining that the pre-determined amount of time has been exceeded, controls the switch to cut-off electrical power supply to the appliance.

The above example may be used for example in the case of operating an appliance such as commercial washing machine or dryer. After payment, the machine turns on but only draws a standby current sufficient to enable a user to select washing options etc. When the user elects to start the wash, the current drawn by the machine increases to a working current which exceeds the pre-determined threshold. At this point, the time starts so that the purchased duration only begins when the wash cycle starts (and not while the machine is being programmed). In this example, the threshold is based on a working current of the appliance (but would be below the actual working current in practice).

In other examples, a timer may not be involved at all and the user may pay for a ‘use’ of the appliance not based on time. For example, the user may wish to use a charging device in order to charge a mobile phone or computer. In this case, the switching device may monitor the current drawn by the charger (or possibly the state of charge of the battery) and only control the switch to cut-off power to the charger after it is determined that the battery is fully charged (for example this could be achieved by monitoring the current drawn by the charger).

Typically, before the switching device is ready to be used by a user, it is set up by a merchant in order to provide the pre-selected payment options. In this regard, the one or more electronic processing devices typically communicate with a merchant device via a wireless communications protocol in order to pre-configure the switch device prior to use by the user. The switching device may communicate with the merchant device via any of the wireless communications protocols previously discussed that may be used to communicate with the user device.

An example of a merchant configuration process shall now be described. In this example, the one or more electronic processing devices firstly generate an initialization token. The initialization token is generated based on the device identifier such as a unique device key assigned to the switching device by the manufacturer. The initialization token is provided to the merchant device in order to configure the switching device with one or more merchant selected payment options. The merchant device is responsive to the initialization token to register the initialization token with the one or more payment options associated with providing electrical power to the appliance (for example $1.00 for 3 minutes, $2.00 for 6 minutes). In one example, this step may be performed using a merchant application executing on the merchant device or via any other suitable interface that allows the merchant to associate payment options with the initialization token.

The merchant device then provides the registered initialization token to a payment system, the payment system responsive to generate provisioning data for use in controlling the switch as will be described in further detail below. The merchant device receives the provisioning data from the payment system and in turn sends the provisioning data to the switching device. The switching device receives the provisioning data and stores it in a data store forming part of the switching device. The provisioning data is used by the switching device to configure the switching device, so that the processing device can at least partially control the switch in accordance with the payment option selected by the user.

As previously mentioned, the initialization token is generated using a device identifier associated with the switch. The device identifier is typically stored in at least one of a local data store and a remote data store (for example associated with the payment system). The local data store typically forms part of the switching device (including the switch and the one or more electronic processing devices). The remote data store is remote to the switching device and may be in communication with the one or more electronic processing devices via a communications network.

The provisioning data for use in controlling the switch typically includes at least one of a merchant identifier associated with the merchant, a device identifier associated with the switch, an indication of the payment options provided by the merchant associated with providing electrical power to the appliance, and instructions for use in controlling the switch in accordance with the payment options. The provisioning data therefore comprises software and/or firmware that is permanently programmed into the read-only memory of the switching device in order to control the specific switch in accordance with the payment options provided by the merchant.

In one example, the one or more electronic processing devices validate the provisioning data prior to storage in the data store. For example, the validation process may include determining that the device key associated with the provisioning data matches the device key of the switching device to which the provisioning data has been sent. This can be achieved in any suitable manner, such as through encryption of the provisioning data using the device identifier, in a manner similar to that described above with respect to the payment token. Furthermore, the validation process may check whether a valid merchant identifier has been provided to ensure that payment for use of appliances connected to the switching device are routed to the appropriate merchant.

It is to be appreciated that the above described method is performed by one or more electronic processing devices forming part of an apparatus that includes a switch for electrically connecting the appliance to an electrical supply. The apparatus further includes a wireless transceiver module and wherein the one or more electronic processing devices communicate with the user device (and merchant device) via the wireless transceiver module. In a specific form, the wireless transceiver module is a Bluetooth™ Low Energy (BLE) transceiver module, although it need not be limited to such and could include any suitable wireless transceiver. The apparatus may further include a local data store as previously described for storing the provisioning data, device identifier etc.

The above components of the apparatus are typically housed within a switch housing that additionally includes a plug for releasable engagement to a wall mounted electrical power outlet, and a socket for receiving an electrical plug associated with the appliance. Alternatively, the apparatus may include a switch housing adapted for securement to a wall mounted electrical power outlet. It is to be understood therefore that the apparatus could form either an adaptor that plugs into a wall socket or it may be embedded into the wall socket or power outlet. In either case, the apparatus is capable of providing an interface between an electrical power supply and an appliance. Whilst typically the power supply will be a mains electricity supply, in some examples the power supply may from a battery or other form of energy storage.

In one example there is accordingly provided a power outlet for providing electrical power, the power outlet including a switch housing embedded into the outlet, the switch housing containing a switch controllable to selectively provide electrical power to an appliance connected to the outlet, and one or more electronic processing devices configured to perform at least one of the methods described herein.

In an alternative example, there is accordingly provided an adaptor releasably engageable to a power outlet, the adaptor including a housing containing a switch that is controllable to selectively provide electrical power to an appliance connected to the power outlet via the adaptor, and one or more electronic processing devices configured to perform at least one of the methods described herein.

In examples where the apparatus monitors current drawn by the appliance in order to control the switch, the apparatus will further includes a current sensor for monitoring a level of current through the switch.

In examples where the payment option is based on a pre-determined time of use of the appliance, the apparatus may further includes a timer used by the one or more electronic processing devices to determine an elapsed time indicative of at least one of a time period since control of the switch was initiated, and a time period since a level of current through the switch exceeded a threshold that may be based on a working current of the appliance for example.

In one example, a user application is provided on the user device for use in controlling the switch to selectively provide power to the appliance. The user device typically includes one or more electronic processing devices receive a service token from a switch controller, the service token being indicative of one or more pre-selected payment options associated with providing power to the appliance. The user processing device then provides the service token to a payment system via a communications network and receives from the payment system an indication of the payment options associated with the service token. The user then selects a payment option via the application which thereby receives an indication of a payment option selected by the user. The payment information is then provided to the payment system in accordance with the payment option selected by the user and the user device receives a payment token from the payment system in response to successful payment using the provided payment information. Finally, the user processing device provides the payment token to the switch controller, the switch controller responsive to the payment token to control the switch to thereby provide electrical power to the appliance at least partially in accordance with the payment option selected by the user.

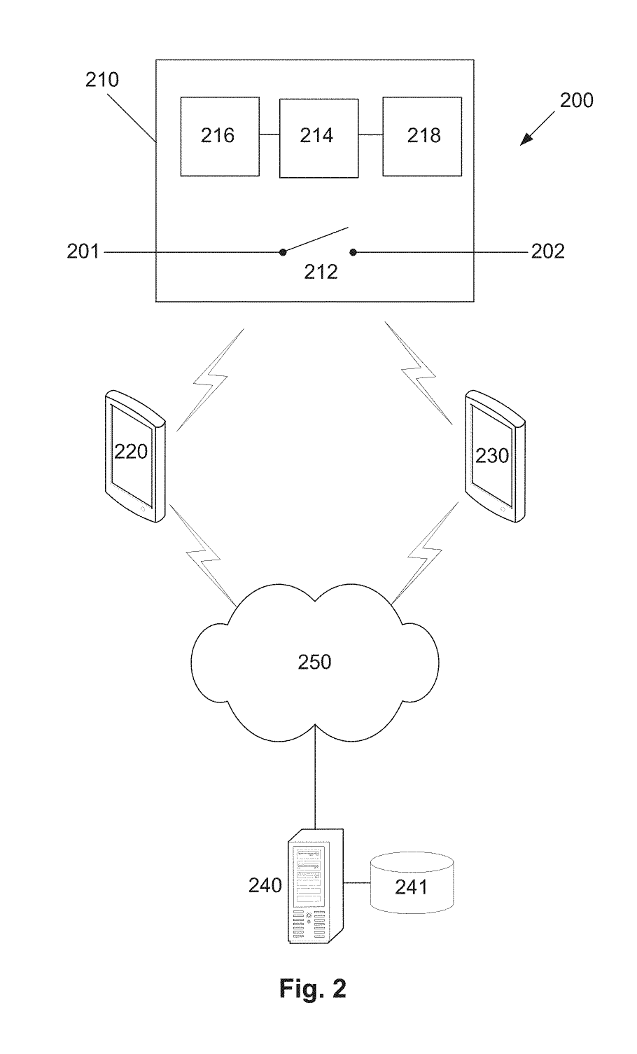

An example of a system for controlling a switch to thereby selectively provide electrical power to an appliance will now be described with reference to FIG. 2.

In this example, the system 200 includes a switching apparatus 210 including a switch controller or processing device 214 in communication with a wireless transceiver module 216 and a data store 218, and a switch 212 electrically interconnected between a plug 201 connectable to a power supply and a socket 202 connectable to the appliance. The switching apparatus 210 is further in communication with one or more user devices 220 optionally running a payment application and one or more merchant devices 230 optionally running a merchant application. The user and merchant devices 220, 230 are in communication with a payment system 240 via a communications network 250. The payment system 240 may be in communication with a database 241.

The communications network 250 can be of any appropriate form, such as the Internet and/or a number of local area networks (LANs). It will be appreciated that the configuration shown in FIG. 2 is for the purpose of example only, and in practice the user devices 220, merchant devices 230, switching apparatus 210 and payment system 240 can communicate via any appropriate mechanism, such as via wired or wireless connections, including, but not limited to mobile networks, private networks, such as an 802.11 network, the Internet, LANs, WANs, or the like, as well as via direct or point-to-point connections, such as Bluetooth, or the like. Typically, the one or more user and merchant devices 220, 230 communicate with the switching apparatus 210 via a wireless communication protocol such as Bluetooth, Wi-Fi Zigbee, or through Near Field Communication (NFC) but not limited to such. The user and merchant devices 220, 230 may typically communicate with the payment system over a mobile network or via the Internet.

User Device 220 and Merchant device 230

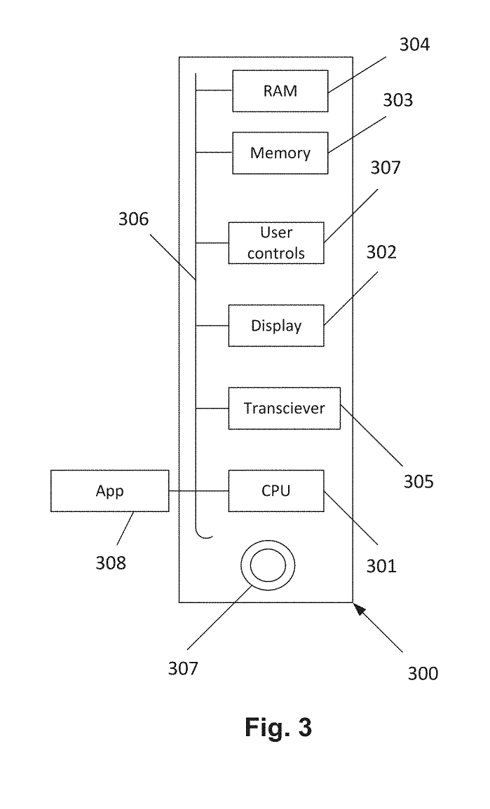

The user device 220 and merchant device 240 of any of the examples herein may be a handheld computer device such as a smart phone or a PDA such as one manufactured by Apple™, LG™, HTC™, Research In Motion™, or Motorola™. The user device 220 or merchant device 230 may include a mobile computer such as a tablet computer. An exemplary embodiment of a user device 300 is shown in FIG. 3. As shown, the device 300 includes the following components in electronic communication via a bus 306:
1. a display 302;
2. non-volatile memory 303;
3. random access memory (“RAM”) 304;
4. N processing components 301;
5. a transceiver component 305 that includes N transceivers; and
6. user controls 307.

Although the components depicted in FIG. 3 represent physical components, FIG. 3 is not intended to be a hardware diagram; thus many of the components depicted in FIG. 3 may be realized by common constructs or distributed among additional physical components. Moreover, it is certainly contemplated that other existing and yet-to-be developed physical components and architectures may be utilized to implement the functional components described with reference to FIG. 3.

The display 302 generally operates to provide a presentation of content to a user, and may be realized by any of a variety of displays (e.g., CRT, LCD, HDMI, micro-projector and OLED displays). And in general, the non-volatile memory 303 functions to store (e.g., persistently store) data and executable code including code that is associated with the functional components of a browser component and applications, and in one example, a payment application 308 executing on the user device 220 and a merchant application executing on the merchant device 230. In some embodiments, for example, the non-volatile memory 303 includes bootloader code, modem software, operating system code, file system code, and code to facilitate the implementation of one or more portions of the payment application 308 as well as other components well known to those of ordinary skill in the art that are not depicted for simplicity.

In many implementations, the non-volatile memory 303 is realized by flash memory (e.g., NAND or ONENAND memory), but it is certainly contemplated that other memory types may be utilized as well. Although it may be possible to execute the code from the non-volatile memory 303, the executable code in the non-volatile memory 303 is typically loaded into RAM 304 and executed by one or more of the N processing components 301.

The N processing components 301 in connection with RAM 304 generally operate to execute the instructions stored in non-volatile memory 303 to effectuate the functional components. As one of ordinarily skill in the art will appreciate, the N processing components 301 may include a video processor, modem processor, DSP, graphics processing unit (GPU), and other processing components.

The transceiver component 305 includes N transceiver chains, which may be used for communicating with external devices via wireless networks. Each of the N transceiver chains may represent a transceiver associated with a particular communication scheme. For example, each transceiver may correspond to protocols that are specific to local area networks, cellular networks (e.g., a CDMA network, a GPRS network, a UMTS networks), and other types of communication networks.

Switching apparatus 210

A suitable switching apparatus 210 for use in the system for controlling a switch to thereby selectively provide electrical power to an appliance described in anyone of the above examples is shown in FIG. 2.

In this example, the switching apparatus 210 includes at least one microprocessor 214, a memory 218, an optional input/output device (not shown), such as a display, keyboard, touchscreen and the like, and an external interface 216, interconnected via a bus. In this example the external interface 216 can be utilised by the switching apparatus 210 when communicating with peripheral devices, such as the user and merchant devices 220, 230 Although only a single interface 216 is shown, this is for the purpose of example only, and in practice multiple interfaces using various methods (e.g. Ethernet, serial, USB, wireless, Bluetooth™ Low Energy (BLE), Near Field Communication (NFC), or the like) may be provided.

In use, the microprocessor 214 executes instructions in the form of applications software stored in the memory 218 to allow communication with the user device 220, for example to provide a service token and receive a payment token therefrom, and the merchant device 240, for example to provide the initialization token and receive the provisioning data. The applications software may include one or more software modules, and may be executed in a suitable execution environment, such as an operating system environment, or the like.

Accordingly, it will be appreciated that the switching apparatus 210 may include any suitable processing system, such as any electronic processing device, including a microprocessor, microchip processor, logic gate configuration, firmware optionally associated with implementing logic such as an FPGA (Field Programmable Gate Array), or any other electronic device, system or arrangement. Thus, in one example, the processing system 210 is a standard processing system such as an Intel Architecture based processing system, which executes software applications stored on non-volatile (e.g., hard disk) storage, although this is not essential.

The switching apparatus 210 may further include a current sensor to monitor current drawn by an appliance, a timer to calculate an elapsed time that power has been provided to the appliance and a housing having optional plug and socket interfaces in which the various components of the apparatus are located.

### Payment System 240

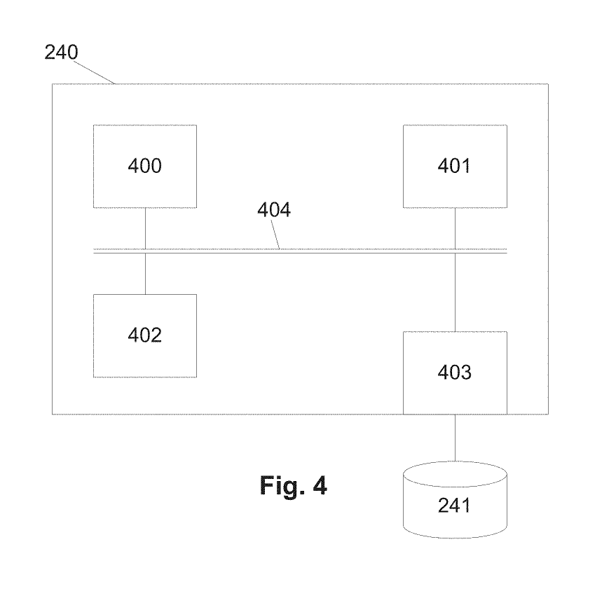

A suitable payment system 240 for use in the system described in anyone of the above examples is shown in FIG. 4.

In this example, the payment system 240 is a server that includes at least one microprocessor 400, a memory 401, an optional input/output device 402, such as a display, keyboard, touchscreen and the like, and an external interface 403, interconnected via a bus 404 as shown. In this example the external interface 403 can be utilised for connecting the payment server 410 to peripheral devices, such as user and merchant devices 220, 230, the communication networks 250, databases 241, other storage devices, or the like. Although a single external interface 403 is shown, this is for the purpose of example only, and in practice multiple interfaces using various methods (e.g. Ethernet, serial, USB, wireless or the like) may be provided.

In use, the microprocessor 400 executes instructions in the form of applications software stored in the memory 401 to allow communication with the user device 220, for example to receive a service token and to provide payment options, and the merchant device 230, for example to receive the registered initialization token and to provide provisioning data. The applications software may include one or more software modules, and may be executed in a suitable execution environment, such as an operating system environment, or the like.

Accordingly, it will be appreciated that the payment system 240 may be formed from any suitable processing system, such as any electronic processing device, including a microprocessor, microchip processor, logic gate configuration, firmware optionally associated with implementing logic such as an FPGA (Field Programmable Gate Array), or any other electronic device, system or arrangement. However, the POS device 210 may also be formed from a suitably programmed PC, Internet terminal, lap-top, or hand-held PC, a tablet, or smart phone, or the like. Thus, in one example, the processing system 210 is a standard processing system such as an Intel Architecture based processing system, which executes software applications stored on non-volatile (e.g., hard disk) storage, although this is not essential.

In other examples, such as described above, the payment system is formed of multiple computer systems interacting, for example, via a distributed network arrangement. As distributed networking is known in the art, it will not be described further in more detail.

In particular, the payment system may include or be in communication with a number of processing systems associated with each of an issuer, acquirer, card network and payment gateway, or alternatively, the payment system may be any one or more of these entities.

In one example as will be well understood in the art, the payment system sends the user account information and payment information to the merchant's acquirer. The acquirer then requests that the card network get an authorization from the user's issuing bank. The card network submits the transaction to the issuer for authorization and the issuing bank then authorizes the transaction if the account has sufficient funds to cover the amount payable. The issuer then routes payment to the acquirer who then deposits the payment into the merchant's account.

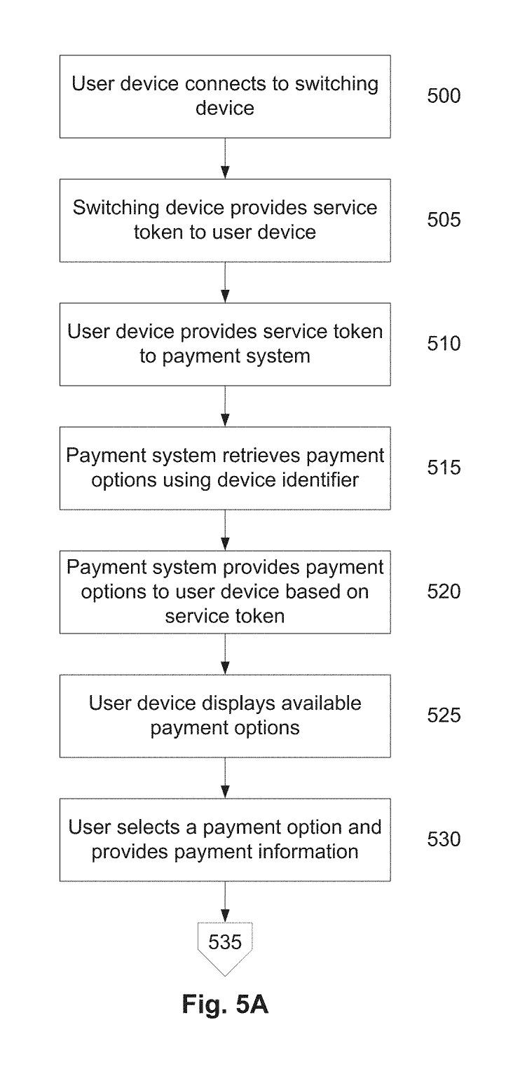

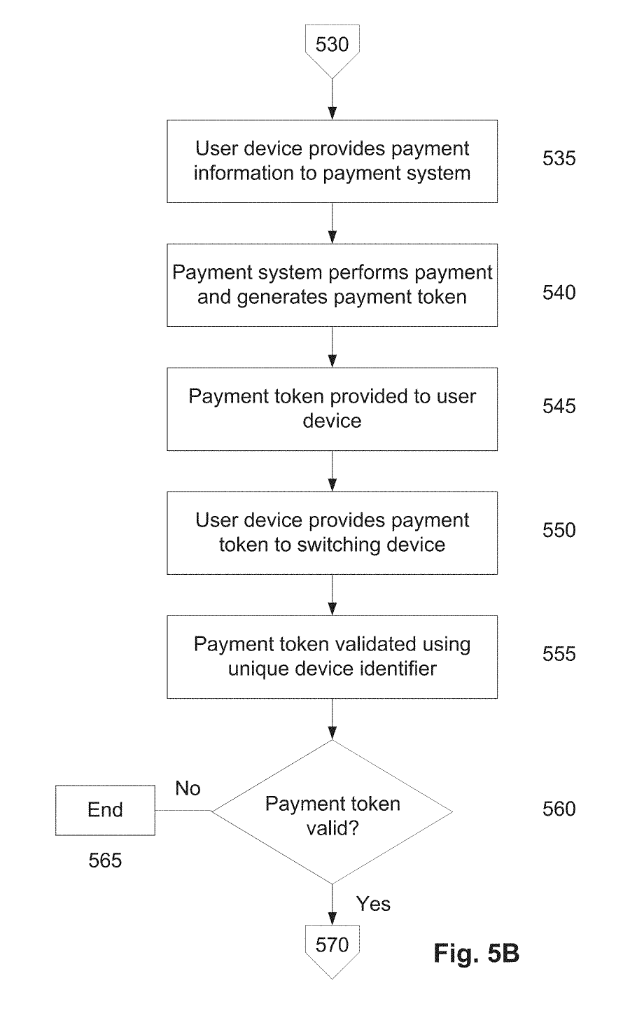

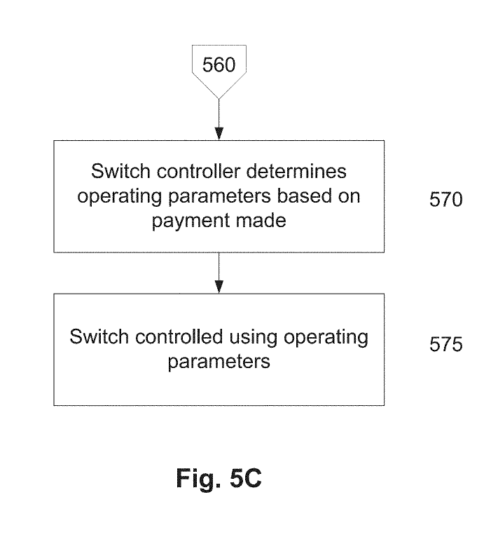

To illustrate further features of preferred practical implementations of the method, a further detailed example of a method of controlling a switch to thereby selectively provide electrical power to an appliance will now be described with reference to FIGS. 5A-5C.

At step 500, a user connects or pairs their user device to a switching device, for example through Bluetooth connectivity, Zigbee, Wi-Fi or any other suitable wireless communications protocol. Once a connection has been established, the switching device provides a service token to the user device at step 505. The user device then provides the service token to a payment system, such as a payment server at step 510. The user device may provide the service token to the payment system in accordance with instructions provided by the user through a payment application executing on their device or other suitable interface. In one example, the service token could be sent from the user device via a text message to the payment server.

At step 515, the payment system retrieves payment options (pre-selected by a merchant) from a data store using the service token which will typically be associated with a device identifier such as a unique device key. In this way, payment options applicable for a particular device can be linked to the device using the service token and device identifier. At step 520, the payment system provides the payment options to the user device based on the service token. The available payment options are then displayed on a user interface of the user device including for example an interface provided by a payment application at step 525.

At step 530, the user selects a suitable payment option and provides payment information. This may be done through a digital wallet or alternatively the user may enter their bank account or card details as would typically occur in a standard ecommerce transaction with a merchant. The payment information is provided by the user device to the payment system at step 535.

At step 540, the payment system performs the payment and generates a payment token which will be indicative of the payment option selected by the user and be associated with the device identifier for the purposes of validation. The payment system may perform the payment in accordance with standard payment processing techniques involving an acquirer, card network, and issuer and optionally a payment gateway.

At step 545, the payment token is provided to the user device via the communications network (e.g. mobile network, Internet etc.). The user device then provides the payment token to the switching device in accordance with an instruction from the user to do so. The payment token may then be validated using the unique device identifier at step 555 to ensure that the correct device has received the payment token and that the payment option selected is valid for the particular device.

At step 560, the switching device determines whether the payment token is valid. If it is found to not be valid then the process ends at step 565. Otherwise, the process proceeds to step 570 where the switching device determines operating parameters based on the payment made (for example, amount of time to provide power to the appliance, current thresholds to monitor etc.). Finally, at step 575 the switch is controlled using the operating parameters to thereby provide power to the appliance in accordance with the payment option selected by the user.

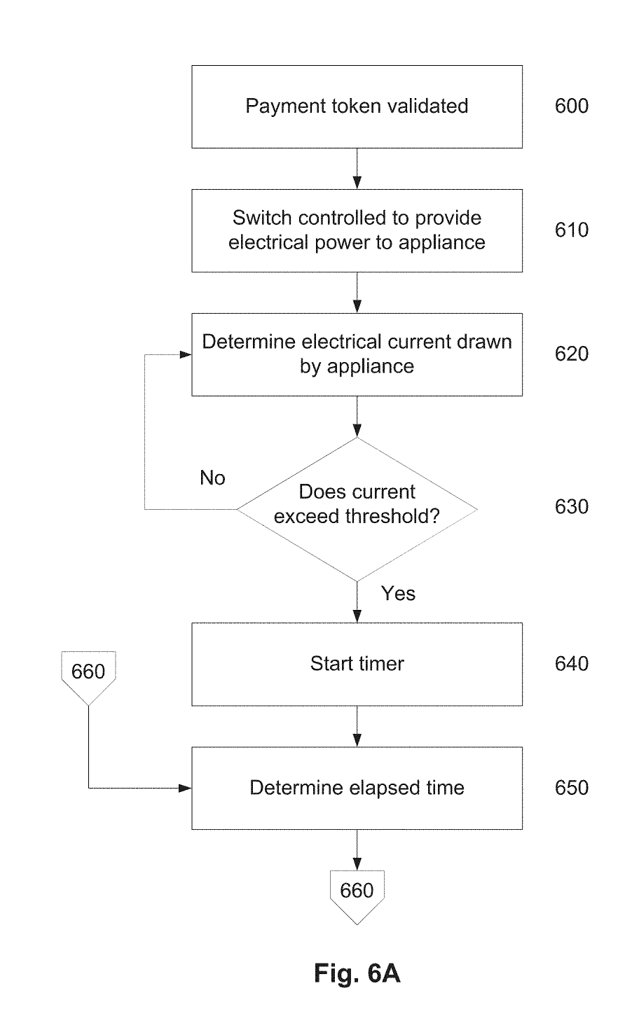

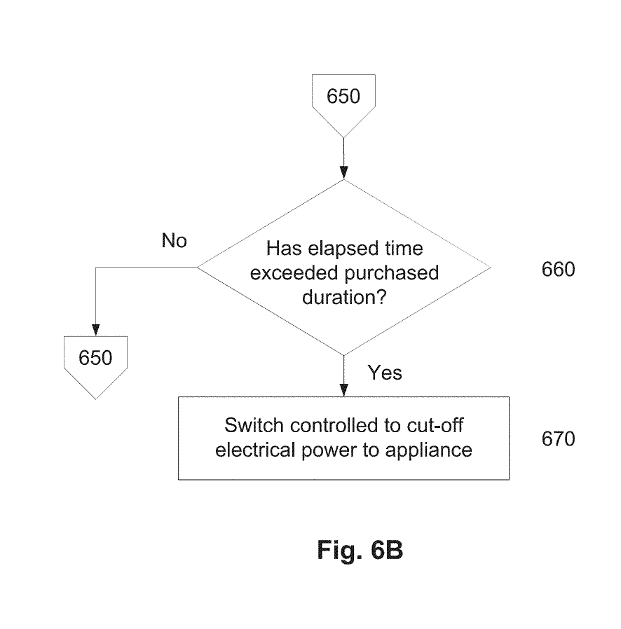

A specific example of a method of controlling a switch to provide power to an appliance using a timer and monitoring a current drawn by the appliance shall now be described with reference to FIGS. 6A-6B.

In this example, the process is described starting from step 600 in which the payment token is validated by the switching device.

In response to successful validation, at step 610 the switch is controlled to provide electrical power to the appliance. At step 620, a current sensor or similar is used by the switch controller to determine the electrical current drawn by the appliance. At step 630, a determination is made as to whether the current drawn by the appliance exceeds a threshold. The threshold is typically pre-determined by the merchant and may be based on the working current of the appliance (although it must be less than the working current but typically more than a standby current). If the current is below the threshold, then the process returns to step 620 and the drawn current is again determined. If the current does exceed the threshold (which is indicative that the user has begun using the appliance under working conditions) a timer is started at step 640.

At step 650, the timer is used to determine an elapsed time that the appliance has been operating under working conditions, for example drawing a working current. At step 640, the switch controller determines whether the elapsed time has exceeded a purchased duration. If it has not, then the process returns to step 650 and the elapsed time is determined again. If the elapsed time has exceeded the purchased duration, then at step 670 the switch is controlled to cut-off electrical power to the appliance. The above described method is particularly suitable for appliances that operate at a standby current when initially turned on allowing a user to program use of the appliance and operate at a working current when said program is started. An example of a suitable appliance would be a washing machine, dryer, dishwasher etc.

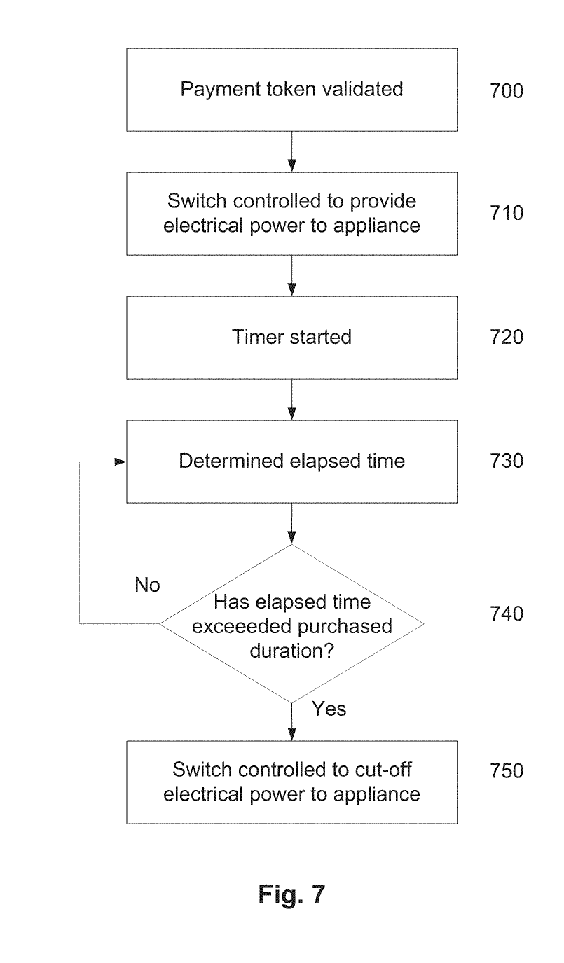

A specific example of a method of controlling a switch to provide power to an appliance using a timer only shall now be described with reference to FIG. 7.

Again in this example, the process is described starting from step 700 in which the payment token is validated by the switching device.

In response to successful validation, at step 710 the switch is controlled to provide electrical power to the appliance. At step 720, a timer is started at the same time that control of the switch is initiated. At step 730, the timer is used to determine an elapsed time that the appliance has been in use. At step 740, the switch controller determines whether the elapsed time has exceeded the purchased duration. If it has not then the process returns to step 730 and the elapsed time is determined again. If the elapsed time has exceeded the purchased duration, then at step 750 the switch is controlled to cut-off electrical power to the appliance.

The above described method is particularly suitable for appliances that draw a substantially constant current when turned on such as lamps, radios, fridge etc. Appliances such as these can readily be controlled simply by turning them on for a pre-determined amount of time before turning them off again.

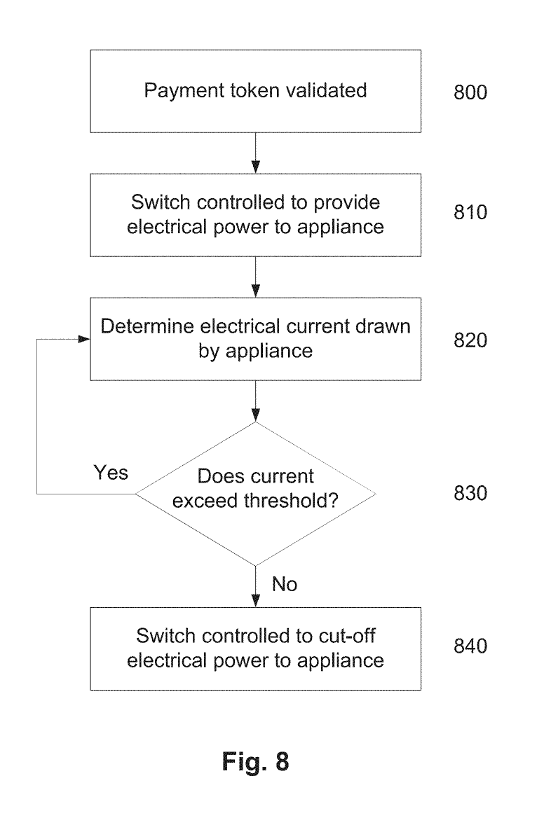

A specific example of a method of controlling a switch to provide power to an appliance based on monitoring current drawn by the appliance only shall now be described with reference to FIG. 8.

Again in this example, the process is described starting from step 800 in which the payment token is validated by the switching device.

In response to successful validation, at step 810 the switch is controlled to provide electrical power to the appliance. At step 820, a current sensor or similar is used by the switch controller to determine the electrical current drawn by the appliance. At step 830, a determination is made as to whether the current drawn by the appliance exceeds a threshold. In this case, the threshold may be indicative of another operating parameter such as a state of charge of the appliance. In this example, if the current exceeds the threshold (for example battery of appliance not fully charged) then the process returns to step 820 and the current draw is determined again. If the current drops below the threshold (indicative that the battery is now fully charged for example) then at step 840 the switch is controlled to cut-off electrical power to the appliance. Whilst this example is particularly useful in the case of charging a battery for example, the current threshold used could be indicative of another operating parameter of the appliance.

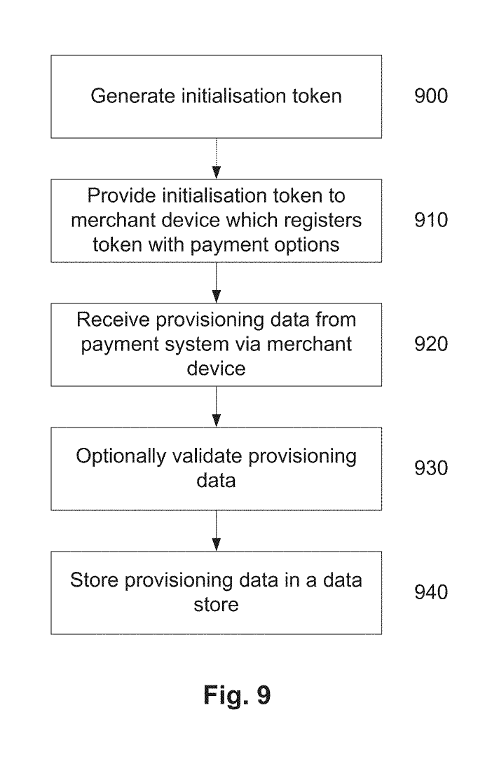

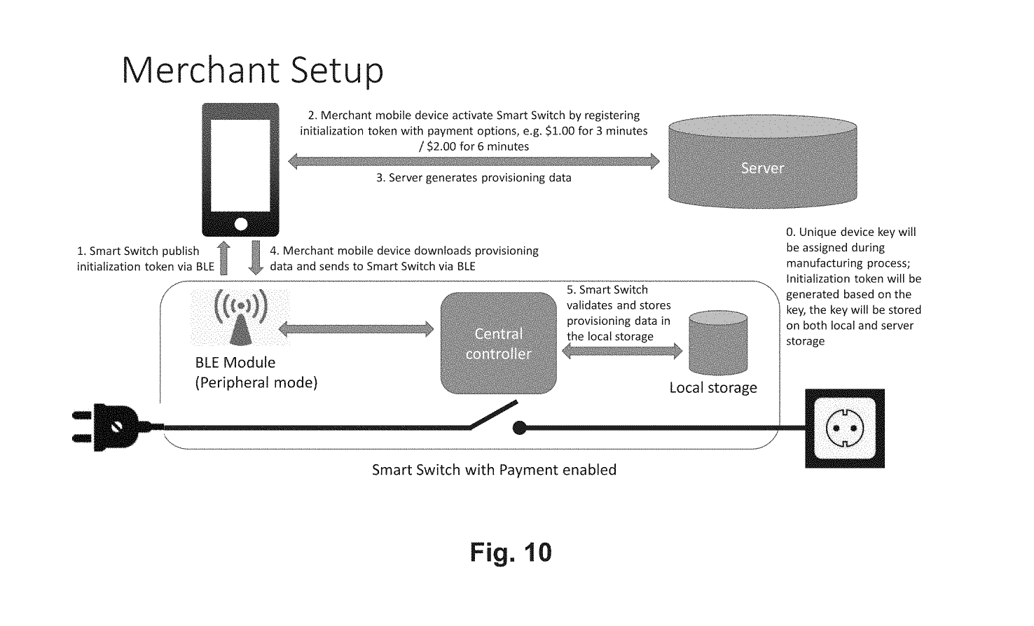

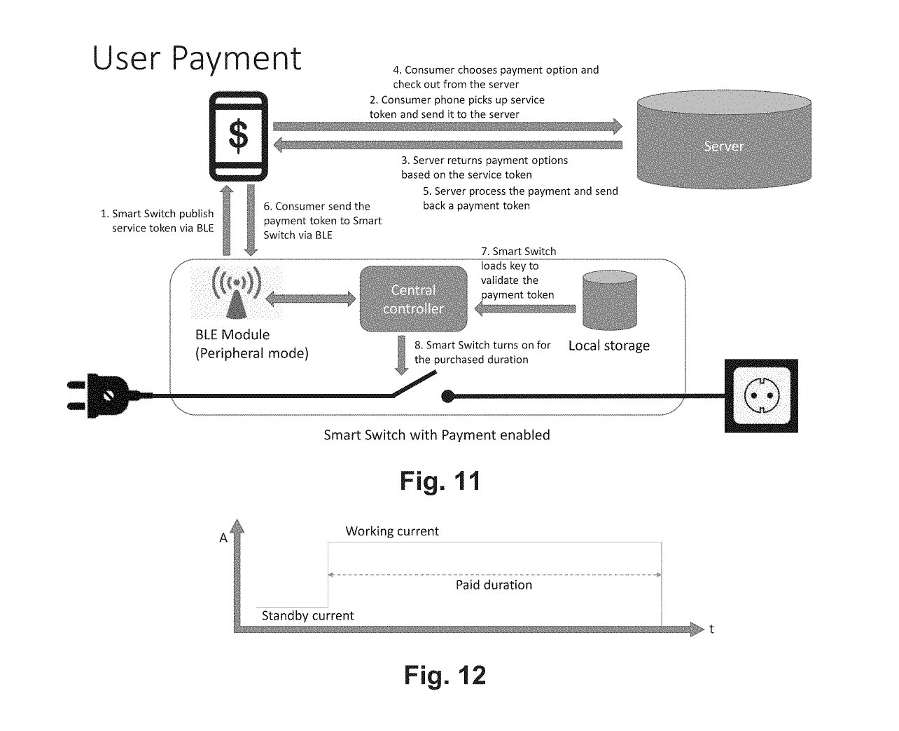

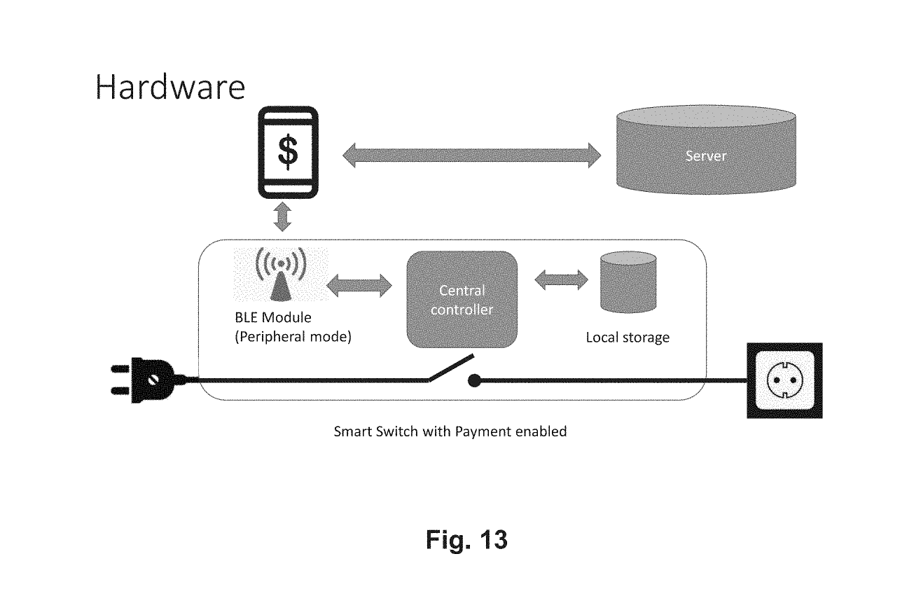

Now referring to FIG. 9, there is shown an example of a method of configuring a switching device that is controllable to thereby selectively provide electrical power to an appliance. The configuration or set-up is typically performed via communication with the merchant device and payment system.

At step 900, an initialisation token is generated for the switching device based on the unique device identifier assigned to the switch. The initialisation token is typically stored on a local data store associate with the switching device along with the device identifier. This step may occur when the device is manufactured or at any stage before the merchant begins configuration of the device. The merchant then connects or pairs their merchant device to the switching device via any suitable form of wireless communication such as Bluetooth, Zigbee or Wi-Fi for example.

At step 910, the switching device provides the initialisation token to the merchant device which is responsive to register the token with payment options associated with providing electrical power to the appliance. In one example, this may be performed through a merchant application executing on the merchant device or through any other suitable interface displayed on the merchant device. The merchant device then provides the registered initialisation token to a payment system, such as a payment server which is responsive to generate provisioning data for use in controlling the switch and providing the provisioning data to the merchant device via a communications network (e.g. mobile network, Internet etc.).

At step 920, the switching device receives the provisioning data from the merchant device via Bluetooth (or Zigbee, Wi-Fi, Near Field Communication (NFC) etc.). The switching device then optionally validates the provisioning date at step 930 to ensure that the device is capable of executing the desired payment options and that the correct device has received the provisioning data. Finally, at step 940, the switching device store the provisioning data in a data store, the provisioning data being used to at least partially control the switch in accordance with the payment option selected by the user. In one example, the provisioning data is in the form of firmware that is permanently stored in read-only memory associated with the switching device. In accordance with the above described process, the switching device is now suitably programmed to execute any one of the available payment options pre-selected by the merchant for the particular switch.

Accordingly, it will be appreciated that in at least one example the above described methods and system may enable electrical appliances to be used on a ‘pay per use’ or subscription basis without requiring traditional forms of payment such as physical money (coins, notes) and bank cards. The ability to restrict usage of appliances in accordance with specific payment options (for example based on duration of use) may also make users more conscious of their energy usage which may lead to reduced energy consumption and more considered decision making around use of appliances. Furthermore, the ability to simply pay for use of appliances may additionally create a new revenue stream for accommodation providers who traditionally rent out rooms having several appliances available for use by their guests.

Throughout this specification and claims which follow, unless the context requires otherwise, the word “comprise”, and variations such as “comprises” or “comprising”, will be understood to imply the inclusion of a stated integer or group of integers or steps but not the exclusion of any other integer or group of integers.

Persons skilled in the art will appreciate that numerous variations and modifications will become apparent. All such variations and modifications which become apparent to persons skilled in the art, should be considered to fall within the spirit and scope that the invention broadly appearing before described.

1. A method of controlling a switch to thereby selectively provide electrical power to an appliance, the method including, in one or more electronic processing devices:
a) providing a service token to a user device, the service token being indicative of one or more pre-selected payment options associated with providing power to the appliance, the user device being responsive to the service token to:
i) provide the service token to a payment system via a communications network;
ii) receive from the payment system an indication of the payment options associated with the service token;
iii) provide payment information to the payment system in accordance with a payment option selected by the user; and;
iv) receive a payment token from the payment system in response to successful payment using the provided payment information;
b) receiving the payment token from the user device; and,
c) using the payment token to control the switch to thereby provide electrical power to the appliance at least partially in accordance with the payment option selected by the user.

2. The method according to claim 1, wherein the one or more pre-selected payment options are associated with at least one of:
a) providing power to the appliance for a pre-determined amount of time;
b) providing a pre-determined amount of electrical power to the appliance; and,
c) providing an amount of power to the appliance in accordance with an electrical parameter of the appliance.

3. The method according to claim 1, wherein the one or more electronic processing devices communicate with the user device via a wireless communications protocol.

4. The method according to claim 1, wherein the method further includes, in the one or more electronic processing devices, validating the payment token using a device identifier associated with the switch.

5. The method according to claim 4, wherein the step of validating the payment token using the device identifier includes at least one of:
a) decrypting the payment token using a key of the device identifier;
b) using the device identifier to determine that the payment token has been received by an intended switching device; and,
c) determining that the payment option selected by the user is valid for the switching device.

6. The method according to claim 1, wherein the method further includes, in the one or more electronic processing devices:
a) controlling the switch to provide electrical power to the appliance;
b) starting a timer;
c) using the timer to determine an elapsed time since control of the switch was initiated;
d) determining whether the elapsed time exceeds a pre-determined amount of time indicative of a purchased duration of electrical power supply to the appliance and,
e) in response to determining that the pre-determined amount of time has been exceeded, controlling the switch to cut-off electrical power supply to the appliance.

7. The method according to claim 1, wherein the method further includes, in the one or more electronic processing devices:
a) monitoring an electrical current drawn by the appliance; and,
b) controlling the switch at least partially in accordance with the current drawn.

8. The method according to claim 7, wherein the method further includes, in the one or more electronic processing devices:
a) controlling the switch to provide electrical power to the appliance;
b) monitoring an electrical current drawn by the appliance;
c) determining if the electrical current exceeds a threshold;
d) in response to determining that the threshold has been exceeded, starting a timer;
e) using the timer to determine an elapsed time since the threshold was exceeded;
f) determining whether the elapsed time exceeds a pre-determined amount of time indicative of a purchased duration of electrical power supply to the appliance; and,
g) in response to determining that the pre-determined amount of time has been exceeded, controlling the switch to cut-off electrical power supply to the appliance.

9. The method according to claim 8, wherein the threshold is based on a working current of the appliance.

10. The method according to claim 1, wherein the method further includes, in the one or more electronic processing devices, communicating with a merchant device via a wireless communications protocol in order to pre-configure the switch device prior to use by the user.

11. The method according to claim 10, wherein the method further includes, in the one or more electronic processing devices:
a) generating an initialization token;
b) providing the initialization token to the merchant device, the merchant device being responsive to the initialization token to:
i) register the initialization token with the one or more payment options associated with providing electrical power to the appliance;
ii) provide the registered initialization token to a payment system, the payment system responsive to generate provisioning data for use in controlling the switch;
iii) receive the provisioning data from the payment system;
c) receive the provisioning data from the merchant device; and,
d) store the provisioning data in a data store, the provisioning data being used to at least partially control the switch in accordance with the payment option selected by the user.

12. The method according to claim 11, wherein the initialization token is generated using a device identifier associated with the switch, the device identifier being stored in at least one of:
a) a local data store, the local data store forming part of a switching device including the switch and the one or more electronic processing devices; and,
b) a remote data store, the remote data store being remote to the switching device and in communication with the one or more electronic processing devices via a communications network.

13. The method according to claim 11, wherein the provisioning data for use in controlling the switch includes at least one of:
a) a merchant identifier associated with the merchant;
b) a device identifier associated with the switch;
c) an indication of the payment options provided by the merchant associated with providing electrical power to the appliance; and,
d) instructions for use in controlling the switch in accordance with the payment options, and wherein the method further includes, in the one or more electronic processing devices, validating the provisioning data prior to storage in the data store.

14. The method according to claim 1, wherein a device identifier associated with the switch is a unique key.

15. Apparatus for controlling a switch to thereby selectively provide electrical power to an appliance, the apparatus including one or more electronic processing devices that:
a) provide a service token to a user device, the service token being indicative of one or more pre-selected payment options associated with providing power to the appliance, the user device being responsive to the service token to:
i) provide the service token to a payment system via a communications network;
ii) receive from the payment system an indication of the payment options associated with the service token;
iii) provide payment information to the payment system in accordance with a payment option selected by the user; and,
iv) receive a payment token from the payment system in response to successful payment using the provided payment information;
b) receive the payment token from the user device; and,
c) use the payment token to control the switch to thereby provide electrical power to the appliance at least partially in accordance with the payment option selected by the user.

16. Apparatus according to claim 15, wherein the apparatus includes a switch for electrically connecting the appliance to an electrical supply.

17. Apparatus according to claim 15, wherein the apparatus includes a wireless transceiver module and wherein the one or more electronic processing devices communicate with the user device via the wireless transceiver module.

18. Apparatus according to claim 15, wherein the apparatus further includes a switch housing including:
a) a plug for releasable engagement to a wall mounted electrical power outlet; and,
b) a socket for receiving an electrical plug associated with the appliance, and wherein the apparatus further includes a switch housing adapted for securement to a wall mounted electrical power outlet.

19. Apparatus according to claim 15, wherein the apparatus further includes a current sensor for monitoring a level of current through the switch, and further including a timer used by the one or more electronic processing devices to determine an elapsed time indicative of at least one of:
a) a time period since control of the switch was initiated; and,
b) a time period since a level of current through the switch exceeded a threshold that is based on a working current of the appliance.

20. A method for use in controlling a switch to thereby selectively provide electrical power to an appliance, the method including, in the one or more electronic processing devices:
a) generating an initialization token;
b) providing the initialization token to the merchant device, the merchant device being responsive to the initialization token to:
i) register the initialization token with one or more payment options associated with providing electrical power to the appliance;
ii) provide the registered initialization token to a payment system, the payment system responsive to generate provisioning data for use in controlling the switch;
iii) receive the provisioning data from the payment system;
c) receiving the provisioning data from the merchant device; and,
d) storing the provisioning data in a data store, the provisioning data being used to at least partially control the switch in accordance with the payment option selected by the user.
